(19) United States
(12) Patent Application Publication
(10) Pub. No.: US 2013/0268313 A1
(43) Pub. Date: Oct. 10, 2013

(54) System and Method for Security Management

(71) Applicants: Thomas B. Ragsdale, Rockford, IL (US); Chandler Anderson, Rockford, IL (US)

(72) Inventors: Thomas B. Ragsdale, Rockford, IL (US); Chandler Anderson, Rockford, IL (US)

(73) Assignee: IRIS CONSOLIDATED, INC., Rockford, IL (US)

(21) Appl. No.: 13/856,981

(22) Filed: Apr. 4, 2013

Related U.S. Application Data
(60) Provisional application No. 61/620,338, filed on Apr. 4, 2012.

(51) Int. Cl. G06Q 10/06

(52) U.S. Cl. CPC G06Q 10/0635
USPC 705/7.28

(57) ABSTRACT

A security evaluation and scoring system includes a computer server in wireless communication with a mobile electronic device. The computer server is configured to receive input from the mobile electronic device, where the input is related to individuals to be evaluated. The server is further configured to evaluate risk, based on a plurality of predetermined parameters, and to provide both a qualitative and quantitative scoring-based risk assessment of the individual, and to output the results of the risk assessment to a display of the mobile electronic device.

### CROSS-REFERENCE TO RELATED PATENT APPLICATIONS

This patent application claims the benefit of U.S. Provisional Patent Application No. 61/620,338, filed Apr. 4, 2012, the entire teachings and disclosure of which are incorporated herein by reference thereto.

### FIELD OF THE INVENTION

This invention generally relates to a wireless system for providing risk assessment information to security personnel.

### BACKGROUND OF THE INVENTION

There is a common need in organizations of all types (including commercial, industrial, governmental, etc.) for effective and efficient reporting systems to provide intelligence that can be applied primarily to the unique data and business needs of the organization. There is also a need for widely-accessible platforms that allow organizational members means to gather data across time from many different types of metrics in a way that makes it possible to evaluate the data in a fair and qualitative manner. Systems that allow for such data gathering with respect to dissimilar metrics to a relative scale for purposes of evaluation would allow the aforementioned organizations to test and evaluate implemented strategies, and to design new strategies.

Embodiments of the present invention provide such a system. These and other advantages of the invention, as well as additional inventive features, will be apparent from the description of the invention provided herein.

### BRIEF SUMMARY OF THE INVENTION

In one aspect, embodiments of the invention provide a security evaluation and scoring system that includes a computer server in wireless communication with a mobile electronic device. The computer server is configured to receive input from the mobile electronic device, where the input is related to individuals to be evaluated. The server is further configured to evaluate risk, based on a plurality of predetermined parameters, and to provide both a qualitative and quantitative scoring-based risk assessment of the individual, and to output the results of the risk assessment to a display of the mobile electronic device.

In certain embodiments of the invention, the server is configured to communicate with wired network computers via the internet, and in at least one embodiment, the mobile electronic device is a cellular phone. The security evaluation and scoring system may further include one or more mobile electronic devices configured to transmit, to the computer server, data used to update a calculation of the score-based risk assessment.

In a further embodiment, the plurality of predetermined parameters includes a plurality of metrics. Each metric has a metric value, and a plurality of metric values may be combined to generate an overall score. One or more of the plurality of metric values are weighted. In some embodiments, each metric includes a plurality of metric units that each have a metric unit value for a specific time period. Threshold values are applied to each metric unit value to normalize the metric unit values via the generation of a translated common notional value for each metric unit value. In one example, the threshold values may include a first threshold value, which indicates that the metric unit value meets or exceeds the desired value for the metric. A second threshold value may indicate that the metric unit value falls within a range of acceptable, but not desirable, value for the metric, while a third threshold value may indicate that the metric unit value fails to meet the minimum acceptable value for the metric.

In a particular embodiment, the first, second, and third threshold values are displayed graphically by the computer server using a color-coding scheme. Moreover, each of the threshold values represents a specific range of metric unit values. In a more particular embodiment, a multiplier is applied to the translated common notional values to generate a translated metric unit value. Also, a bonus may be added to increase a sum total of the translated metric unit values. The bonus is typically applied when there is a period of improving translated common notional values. The bonus may be a month-over-month bonus, a quarter-over-quarter bonus, or a semi-annual bonus. Additionally, a weighting value may be applied to a sum total of the one or more translated metric unit values.

In a particular embodiment, the security evaluation and scoring system is configured for use by housing authorities to assist property managers in evaluating tenants, case management, and identifying trends that might affect the safety and security of the housing development.

In another aspect, embodiments of the invention provide a method of providing a score-based risk assessment. The method includes defining one or more metrics. Each of the one or more metrics includes one or more metric unit values. The method also includes defining one or more threshold values to categorize the one or more metric unit values. The one or more threshold values each represent a specific range of metric unit values. The method further includes the step of assigning a threshold value to each of the one or more metric unit values to generate one or more translated common notional values, and calculating one or more multipliers for the translated common notional values. The one or more multipliers and one or more translated common notional values generate one or more translated metric values for each metric. The sum of the one or more translated metric values provides a total metric value for each metric. Also, the method includes calculating an overall score by summing the total metric values for each of the one or more metrics.

The method further includes receiving wirelessly transmitted data, (e.g., from a smart phone, tablet computer, or some other type of mobile electronic device) that affects one or more metric unit values. The data received could be a photograph or some other identifying information concerning an individual, a property, or some portion of a property. The method also includes transmitting to a networked personal computer or to a wireless mobile electronic device metrics and scoring data that can be graphically displayed on the networked personal computer or wireless mobile electronic device. The wireless mobile electronic device may be a smart phone or tablet computer. In embodiments, the method also includes a computer server processing the wirelessly transmitted data and recalculating the overall score to reflect any changes resulting from the newly received data.

In a further embodiment, the method includes calculating a bonus that is added to the translated metric value when there is a period of improving translated common notional values. The method may include calculating one of a month-over-month bonus, a quarter-over-quarter bonus, and a semi-annual bonus. A total bonus may be calculate as a sum of these three bonuses. In particular embodiments, the bonus is calculated by dividing a multiplier of the one or more multipliers by the number of metric units used to calculate the multiplier.

Additionally, the method may include assigning a weighting value to each of the one or more metrics. In certain embodiments, calculating one or more multipliers comprises calculating a quarterly multiplier whose value is determined by the formula: QM=(MSP/MSC/4/(3-MBE)+MSP/MSC/4/(3-MBE)/4)*QW, where QM is the quarterly multiplier value, MSP is a metric set maximum value, MSC is a total number of metric blocks within the metric set, MBE is a number of quarterly exceptions, and QV is a quarterly weighting whose value is larger for more recent quarters than for less recent quarters.

In yet another aspect, embodiments of the invention provide a method of calculating and reporting on dissimilar metrics to a relative scale for purposes of risk evaluation. This allows a user to test and evaluate implemented security strategies, and design new security strategies.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic diagram of a security evaluation and scoring system, in accordance with an embodiment of the invention;

FIG. 2 is an illustration of an exemplary screen shot of a metric set, constructed in accordance with an embodiment of the invention;

FIG. 3 is an illustration of an exemplary screen shot of a resident report card, constructed in accordance with an embodiment of the invention;

FIG. 4 is an illustration of an exemplary screen shot of a dashboard display, constructed in accordance with an embodiment of the invention;

FIG. 5 is a flowchart illustrating a basic implementation of the security evaluation and scoring system, in accordance with an embodiment of the invention;

FIGS. 6A and 6B are flowcharts that show a particular example of how a metric value is calculated, according to an embodiment of the invention; and

FIGS. 7 and 8 are illustrations showing exemplary screen shots of an application program interface, constructed in accordance with an embodiment of the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

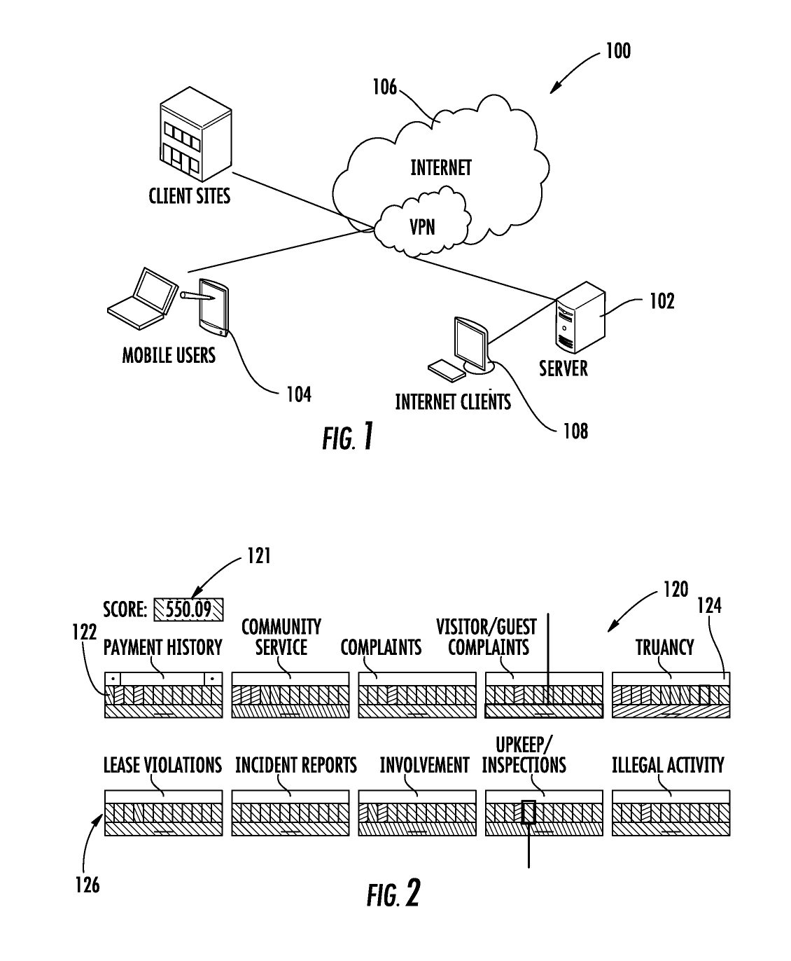

FIG. 1 is a schematic diagram of a security evaluation and scoring system 100, in accordance with an embodiment of the invention. The system 100 includes one or more servers 102 configured to communicate wirelessly with a mobile electronic device 104. The one or more servers 102 are also configured to communicate over a network 106, such as the internet, through a wired connection to a personal computer 108. Embodiments of the present invention provide a security evaluation and scoring system 100 that provides a means to gather data over time from a variety of sources to create different types of metrics to allow for evaluation of data in either a qualitative or quantitative manner. This system 100 allows for the calculation and reporting of various metrics to a relative scale.

In a particular embodiment of the invention, the security evaluation and scoring system 100 is based around metric events, which may have supporting information. Notes, case-management-generated documentation, and other digital documents can be stored with the individual metric event or in some other way with a user.

While the security evaluation and security system 100 can be employed in a variety of applications, in a particular embodiment, the security evaluation and scoring system 100 is configured for use by property managers of large housing developments. Directors of public housing projects can use the system 100 for case management, to evaluate tenants, and to identify trends that might affect the safety and security of the housing development. In this embodiment, the system 100 evaluates tenants based on a series of metrics and calculates an overall score or rating. Independent of the overall score, each metric has an aggregate value or score. Aging of values affects an individual metric value or score.

In a specific embodiment, the metrics are shown for a rolling 12-month period. However, users can customize the display to show multiple rolling or static time periods. In other embodiments, one or more of the metrics are weighted such that the weighted metrics factor more heavily into the overall scoring than unweighted metrics. Of course, it is also possible to arrange the weights such that the weighted metrics factor less heavily into the overall scoring than unweighted metrics. This allows the user to customize the evaluation and scoring in a way that enhances the impact of the most important metrics, while reducing the impact of less important metrics.

In this manner, a user can compare a metric from one person to another, and account for growth or improvement over time. For example, in cases where the system 100 is used to aid in the security for a housing development, two tenants each may have four late rental payments, but if all of the late payments for one tenant occurred more than six months in the past, while the late payments for the other tenant all occurred within the past six months, the former tenant would have a higher score for the metric related to “Payment History” to reflect their improvement over time.

In certain embodiments, an individual metric may be combined with other metrics to form a metric set. The ability to weight metrics based on the individual metrics overall importance, or importance within a metric set, provides an equitable evaluation of the metric relative to the importance to other metrics within the set. Evaluation of groups of individual's metrics combined into a metric set provides insight into a user's overall status within the clients' complete population, or a demographic subset of the entire population. Used to evaluate an individual, in some embodiments, a metric set displays the most recent twelve metric units for each metric within the metric set in a normalized fashion. The metric set value is the weighted cumulative value of all the calculated metrics block values with weighting applied. Weighting allows for one metric to have a higher effect on the overall score than another. The weights can be modified by the user. In a specific example, trending data for individual metrics are represented by color bars displayed within each metric block.

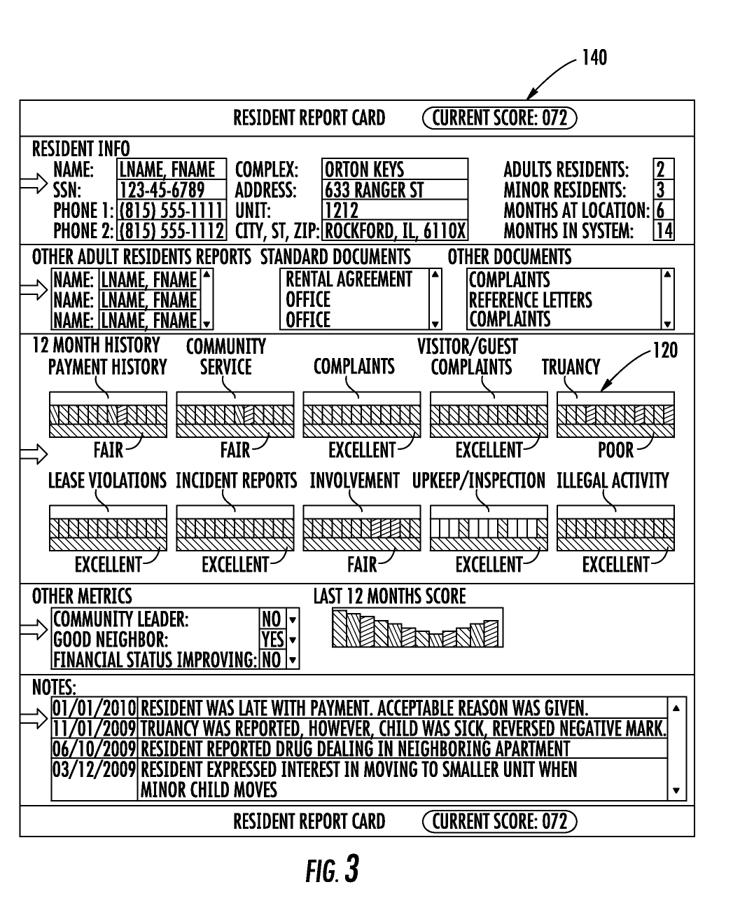

Continuing with the example in which the system 100 is used to aid in the security for a housing development, FIG. 2 is an illustration of an exemplary screen shot of a metric set 120 showing how a tenant could be evaluated. As shown in FIG. 2, the tenant's overall score 121 is shown in the upper left corner of the display. In this example, the tenant is evaluated based on ten different metrics: Payment History, Community Service, Complaints, Visitor Complaints, Truancy, Lease Violations, Incident Reports, Involvement, Upkeep/Inspections, and Illegal Activities. In this example, each metric is evaluated for 12 time intervals represented by the line of 12 rectangular units 122 below each metric title bar 124. Together, the 12 rectangular units 122 form a metric block 126. Each of the twelve rectangular units 122 may be color-coded (e.g., in green, yellow, and red) to indicate tenant performance for that metric in the time period indicated.

In a specific example of how the color-coding would work, the Payment History metric may have thresholds that track the date that rent payment is received for the previous 12 time months. Payment received on the first to sixth day of the month is coded green. Payment received on the seventh to thirteenth day of the month is coded yellow, while payment received on the fourteenth day or later is coded red. In particular embodiments, the thresholds types, ranges, weighting, and overall scoring can be modified, metrics deleted or new metrics added, by the user at any time by the user, and historical data will be recalculated and the overall score based on the new criteria. The use of color coding in this manner allows for simplified trend analysis and easier comparison of different metrics.

In a particular embodiment, the rectangular unit 122 to the farthest right in the line of rectangular units 122 represents the current time period. The rectangular unit 122 to its immediate left represent the time period immediately prior to the current time period. Thus, each successive rectangular unit 122 represents the time period immediately preceding that represented by the rectangular unit 122 to its immediate right. In those embodiments where there are twelve rectangular units 122 and where the time period equals one month, the metrics shown in FIG. 2 represent tenant performance for the past year, and provides a rolling 12-month metric value that is updated every month.

Each of the metrics is a consistent, repeatable measurable parameter. Thresholds for a metric define the rules to convert a raw metric value to a notionally common scale so that different metrics can be evaluated against one another. Thresholds for each metric are determined by the user or by evaluation of historical data to form a normal distribution of data. In a particular embodiment, the system 100 includes three defined thresholds, further including a fourth state of exception within the threshold. In a particular embodiment, the system 100 has a common scale that allows for three normalized states in which the tenant: 1) meets or exceeds the desired value for the metric; 2) falls within a range of acceptable, but not desirable, values for the metric; and 3) has unacceptable values for the metric. Also, scoring for individual metrics over an entire time period may be adjusted based on the time elapsed since the last event, and/or based positive or negative trending of results, such that the most recent events are weighted more heavily than less recent events. Also, additional weight may be given to positive trends within a metric. Metrics data can be viewed across all demographics, or across any selected single or subgroup of demographics.

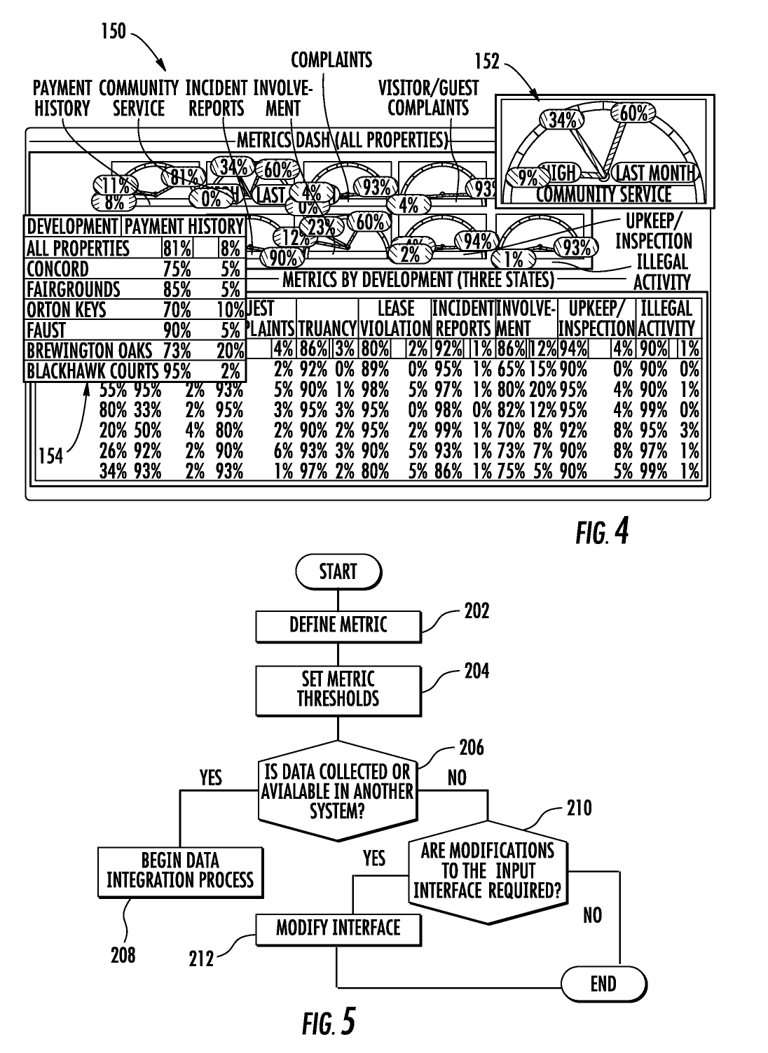

In certain embodiments of the invention, the metric set 120 of FIG. 2 is incorporated into a resident report card 140, an example of which is shown in FIG. 3. As shown, the resident report card 140 provides a comprehensive snapshot of the relevant information for a particular tenant, for example in a public housing development. In addition to the metric set 120 of FIG. 2, the resident report card 140 may include personal information on the resident and family members living with the resident, lease information, access to various documents related to the resident, other metrics not shown in the metric set 120, and any notes or incident reports concerning the resident, such as might be filed by security officers or administrative personnel working for the housing development.

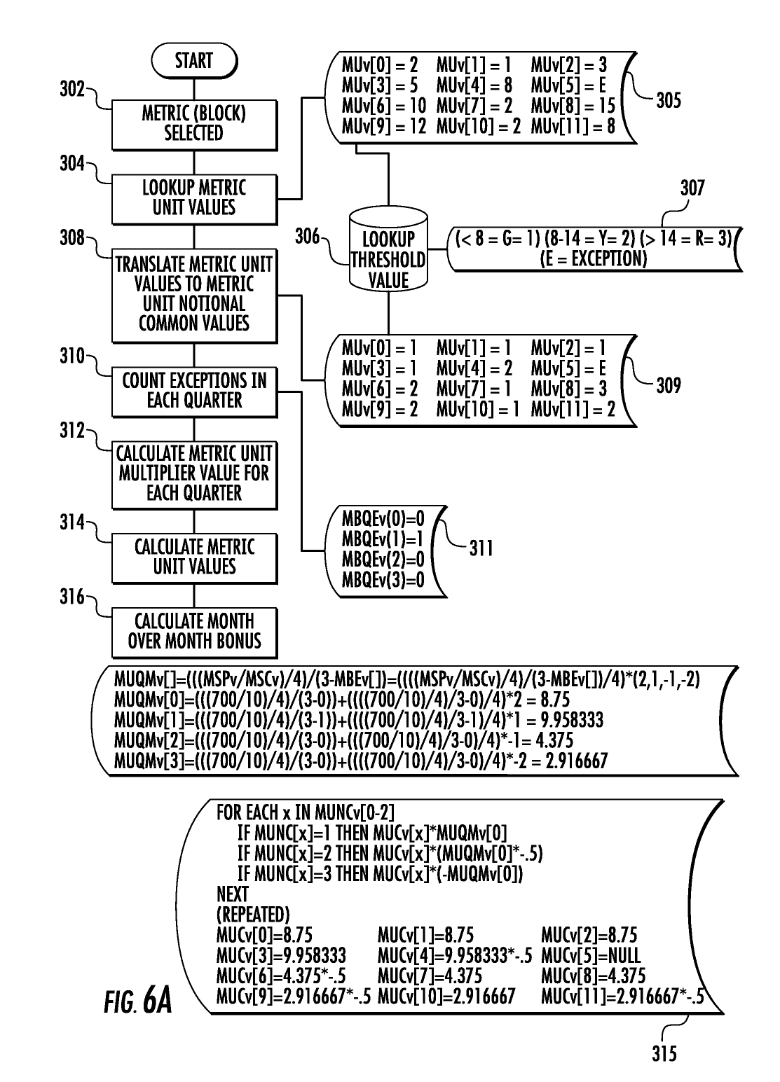

In some instances, results may be displayed on one of a variety of dashboard displays, which may display color-coded ratings in red, yellow, and green, for example, to display overall scores and scores within individual metrics. FIG. 4 is an illustration of an exemplary dashboard display 150, constructed in accordance with an embodiment of the invention. For example, individual gauges 152 may be used to display various metrics over a fixed time period, or a single metric over multiple time periods. In an example, values 154 may be expressed on the dashboard as a percentage of tenants with scores ranking in each of the levels defined by the user.

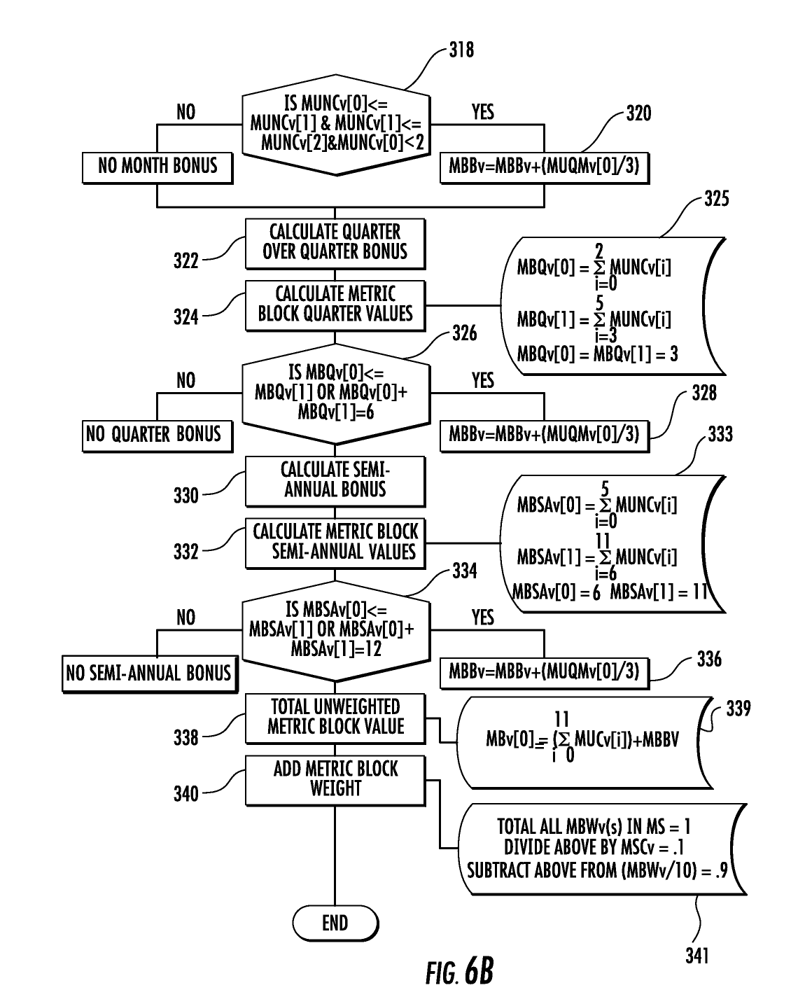

FIG. 5 is a flowchart that illustrates a basic implementation of the security evaluation and scoring system 100, in accordance with an embodiment of the invention. As shown in FIG. 5, the first step in the implementation is defining the metrics 202 to be used in overall scoring. The second step is setting thresholds 204 for each metric. Once the thresholds have been set, a determination of data availability 206 must be made. Specifically, if the data needed to provide a metric value are not available on the system 100, the process of integrating the input of the external data 208 into the system 100 can commence. If the data needed to provide a metric value are available on the system 100, it must be determined whether the current interface is capable of accommodating the metric, and whether modifications to the system input interface are required 210 to acquire the necessary data. If the data for the desired metric is being collected externally, an assessment must be made as to the viability of systematically gathering the data from an external system. If modifications are required, the interface is modified 212.

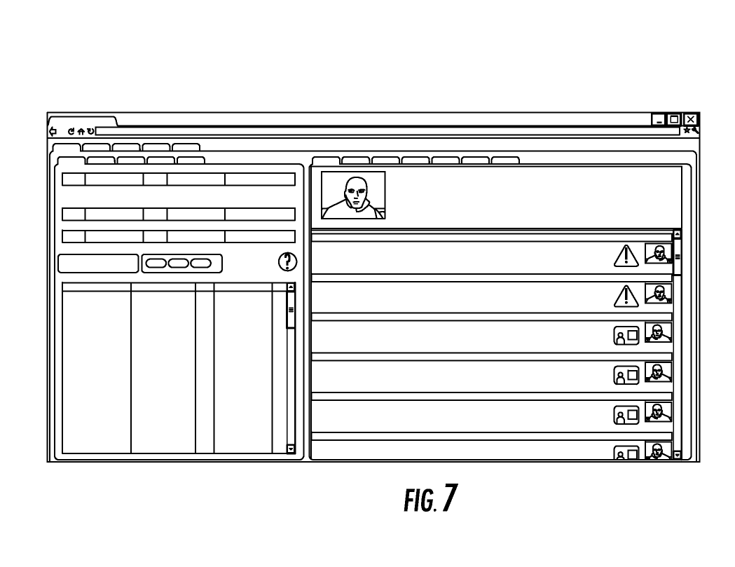

FIGS. 6A and 6B are flowcharts that show a specific example of how metrics are calculated, according to an embodiment of the invention. Initially, a metric block is selected 302. Once the metric block is selected 302, the system 100 (shown in FIG. 1) performs a lookup of metric unit values 304 for the most recent time periods being evaluated. Referring to the above example in which the system 100 is used to evaluate tenants in a housing development, there may be 12 metric unit values based on a rolling 12-month period. A first table 305 shows exemplary values for the 12 metric units. The system 100 also performs a lookup of the threshold values 306 associated with the metric unit values of the selected metric block. A second table 307 shows three thresholds as they could be applied the 12 metric unit values in first table 305.

The metric unit values are translated into notional common values 308. A third table 309 shows the metric units ranked according to their threshold values. The exceptions are counted for each quarter 310. A fourth table 311 shows the total number of exceptions, for the 12 metric unit values, for each of four quarters. An exception is equivalent to a null value for the metric unit, as shown in FIGS. 6A and 6B.

The metric unit multiplier is calculated for each quarter 312. A fifth table 313 provides an example of these calculations. The metric unit multipliers are used to calculate translated metric unit values 314. A sixth table 315 provides an example of these calculations. In the example shown, a quarterly multiplier has a value determined by the formula: QM=(MSP/MSC/4/(3-MBE)+MSP/MSC/4/(3-MBE)/4)*QW, where QM is the quarterly multiplier value, MSP is a metric set maximum value, MSC is a total number of metric blocks within the metric set, MBE is a number of quarterly exceptions, and QV is a quarterly weighting whose value is larger for more recent quarters than for less recent quarters. For example, in the embodiment of FIGS. 6A and 6B, the QV equals two for the most recent quarter, and one for the preceding quarter. The QV is negative one for third most recent quarter, and negative two for the preceding fourth most recent quarter.

While the embodiment of FIGS. 6A and 6B show calculations that include quarterly values for exceptions and metric unit multipliers, alternate embodiments may use different time periods and may group these time period such that the groups contain greater or fewer than the three contained in the quarterly groupings shown in FIGS. 6A and 6B. A month-over-month bonus is calculated 316. A condition for the month-over-month bonus 318 determines whether this bonus is awarded. In the example shown, a bonus is awarded if the most recent monthly score meets a predetermined threshold, and is better than or equal to the previous monthly score, which, in turn, is better than or equal to the next previous monthly score. If a month-over-month bonus is to be awarded, the bonus may be calculated using the formula shown in step 320. Bonuses are calculated to reward positive trends in tenant behavior by awarding points for consistent improvement over time.

Then, a quarter over quarter bonus is calculated 322. Metric block quarter values are calculated 324. A seventh table 325 provides an example for how to calculate metric block quarter values. A condition for the quarter-over-quarter bonus 326 determines whether this bonus is awarded. In the example shown, a bonus is awarded if the most recent quarterly score is better than or equal to the previous quarterly score. If a quarter-over-quarter bonus is to be awarded, the bonus may be calculated using the formula shown in step 328.

Next, a semi-annual bonus is calculated 330. Metric block semi-annual values are calculated 332. An eighth table 333 provides an example for how to calculate metric block semi-annual values. A condition for the semi-annual bonus 334 determines whether this bonus is awarded. In the example shown, a bonus is awarded if the most recent semi-annual score is better than or equal to the previous semi-annual score. If a semi-annual bonus is to be awarded, the bonus may be calculated using the formula shown in step 336. In the embodiment of FIGS. 6A and 6B, the total bonus value is the sum of the month-over-month bonus, the quarter-over-quarter bonus, and the semi-annual bonus. In particular embodiments, the bonus is calculated by dividing a multiplier of the one or more multipliers by the number of metric units used to calculate the multiplier. For example, a quarterly multiplier would be divided by three, which is the number of months (and metric units) in a quarter.

The total unweighted metric block value is calculated 338. A ninth table 339 provides a sample calculation for the total unweighted metric block value. Metric block weights are added to the calculation 340 to generate a metric block weighted value. In at least one embodiment, the metric block weighted value is calculated 341 by totaling the metric weighted values for a metric set, dividing that total by the number of metrics in the metric set and subtracting the result from the total to arrive at the weighting factor, which is applied to the unweighted metric block value calculated in step 338.

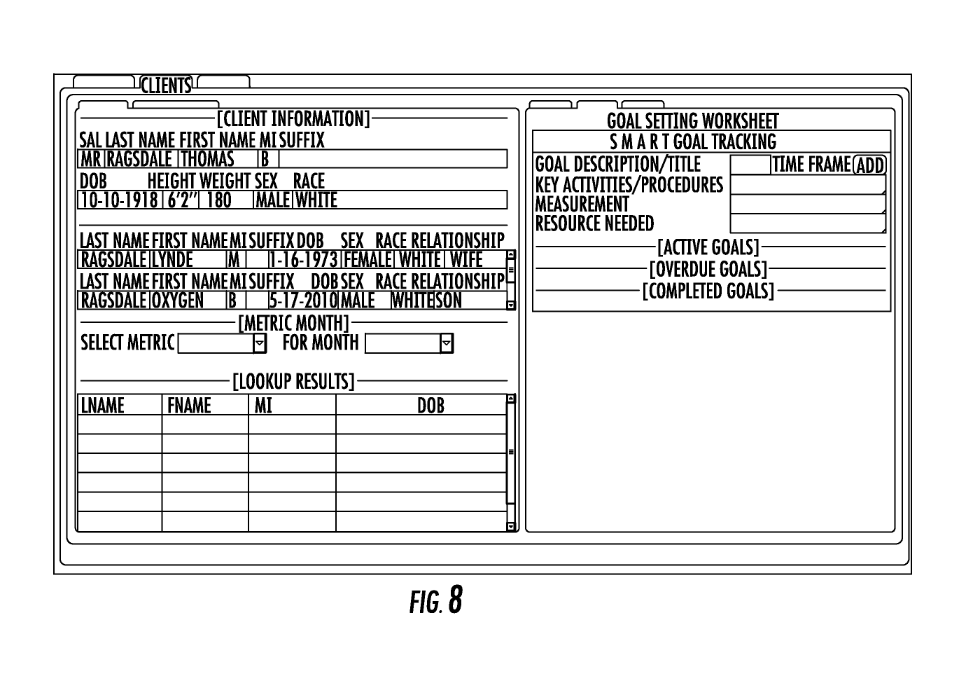

The security evaluation and scoring system 100 described in examples above is designed to increase the safety and security for a housing development by providing security officers, in the field and in the central office, with critical data concerning tenants, the property, and relevant external factors when it is needed. In a particular embodiment of the invention, this is accomplished via an application program interface (API) such as shown in FIGS. 7 and 8. The API of FIG. 7 shows an exemplary personal profile for a tenant. The profile may contain a photo and personal information, along with any incidents involving the tenant, known relatives and associates, etc. Like the resident report card referenced above, the personal profile may be accessed via a personal computer 108 or mobile electronic device 104 (shown in FIG. 1).

The security evaluation and scoring system 100 (shown in FIG. 1) allows for a two-way flow of information. Specifically, security officers in the field who encounter tenants or respond to an incident call can use their mobile electronic device 104 to enter, into the server 102, information learned at the site of the incident, or directly from the tenant. In a specific example, the security officer may use the mobile electronic device 104 to photograph individuals at the scene of an incident. The photographs can be transmitted to the server 102 and compared to those in the system database. While still at the scene, the security officer can get the results of the comparison and determine if any of the individuals are current or former tenants, or individuals who have been involved in previous incidents. The security officer can enter details regarding the incident and receive from the system 100, for example, updated information regarding the history of the individuals involved. The updated information, which could include an updated metric set and overall score, is then available to other security officers in the field and at the central office.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A security evaluation and scoring system comprising:
a computer server in wireless communication with a mobile electronic device, the computer server configured to receive input from the mobile electronic device, the input related to an individual or property to be evaluated;
wherein the server is further configured to provide a score-based risk assessment of the individual or property based on a plurality of predetermined parameters, and to transmit the results of the risk assessment to a display of the mobile electronic device.

2. The security evaluation and scoring system of claim 1, wherein the server is configured to communicate with wired network computers via the internet.

3. The security evaluation and scoring system of claim 1, wherein the mobile electronic device is a cellular phone.

4. The security evaluation and scoring system of claim 1, further comprising one or more mobile electronic devices configured to transmit, to the computer server, data used to update a calculation of the score-based risk assessment.

5. The security evaluation and scoring system of claim 1, wherein the plurality of predetermined parameters comprises a plurality of metrics, each metric having a metric value, wherein a plurality of metric values are combined to generate an overall score.

6. The security evaluation and scoring system of claim 5, wherein one or more of the plurality of metric values are weighted.

7. The security evaluation and scoring system of claim 5, wherein each metric comprises a plurality of metric units each having a metric unit value for a specific time period, and wherein threshold values are applied to each metric unit value to normalize the metric unit values via the generation of a translated common notional value for each metric unit value.

8. The security evaluation and scoring system of claim 7, wherein a first threshold values indicates that the metric unit value meets or exceeds the desired value for the metric, a second threshold values indicates that the metric unit value falls within a range of acceptable, but not desirable, values for the metric, and a third threshold value indicates that the metric unit value fails to meet the minimum acceptable value for the metric.

9. The security evaluation and scoring system of claim 8, wherein the first, second, and third threshold values are displayed graphically by the computer server using a color-coding scheme.

10. The security evaluation and scoring system of claim 8, wherein each of the threshold values represents a specific range of metric unit values.

11. The security evaluation and scoring system of claim 7, wherein a multiplier is applied to each translated common notional value to generate a translated metric unit value for each translated common notional value.

12. The security evaluation and scoring system of claim 11, wherein a bonus is added to increase a sum total of the translated metric unit value, the bonus being applied when there is a period of improving translated common notional values.

13. The security evaluation and scoring system of claim 12, wherein the bonus is one of a month-over-month bonus, a quarter-over-quarter bonus, and a semi-annual bonus.

14. The security evaluation and scoring system of claim 11, wherein a weighting value is applied to a sum total of the one or more translated metric unit values.

15. A method of providing a score-based risk assessment, the method comprising the steps of:
defining one or more metrics, wherein each of the one or more metrics includes one or more metric unit values, defining one or more threshold values to categorize the one or more metric unit values, the one or more threshold values each representing a specific range of metric unit values;
assigning a threshold value to each of the one or more metric unit values to generate one or more translated common notional values;
calculating one or more multipliers for the translated common notional values, the one or more multipliers together with the one or more translated common notional values generating one or more translated metric values for each metric, the sum of the one or more translated metric values providing a total metric value for each metric; and
calculating an overall score by summing the total metric values for each of the one or more metrics.

16. The method of claim 16, further comprising calculating a bonus that is added to the overall score when there is a period of improving translated common notional values.

17. The method of claim 16, wherein calculating a bonus comprises calculating one of a month-over-month bonus, a quarter-over-quarter bonus, and a semi-annual bonus.

18. The method of claim 16, wherein calculating a bonus comprises dividing a multiplier of the one or more multipliers by the number of metric units used to calculate the multiplier.

19. The method of claim 15, further comprising assigning a weighting value to each of the one or more metrics.

20. The method of claim 15, further comprising receiving wirelessly transmitted data that affects one or more metric unit values.

21. The method of claim 20, wherein receiving wirelessly transmitted data comprises receiving wirelessly transmitted data transmitted from a smart phone or tablet computer.

22. The method of claim 21, wherein receiving wirelessly transmitted data comprises receiving a wirelessly transmitted photograph or other identifying information for an individual or for a property.

23. The method of claim 20, further comprising a computer server processing the wirelessly transmitted data and recalculating the overall score.

24. The method of claim 15, further comprising transmitting metrics and scoring data wirelessly to a mobile electronic device or to a networked personal computer, the metrics and scoring data configured to be graphically displayed on the mobile electronic device or networked personal computer.

25. The method of claim 24, wherein the mobile electronic device comprises a smart phone or tablet computer.

26. The method of claim 15, wherein assigning a threshold value to each of the one or more metric unit values comprises assigning a threshold value that corresponds to a predetermined range of metric unit values.

27. The method of claim 15, wherein calculating one or more multipliers comprises calculating a quarterly multiplier whose value is determined by the formula:
QM=(MSP/MSC/4/(3-MBE)+MSP/MSC/4/(3-MBE)/4)*QW;
where QM is the quarterly multiplier value, MSP is a metric set maximum value, MSC is a total number of metric blocks within the metric set, MBE is a number of quarterly exceptions, and QV is a quarterly weighting whose value is larger for more recent quarters than for less recent quarters.
